(19) United States
(12) Patent Application Publication
(10) Pub. No.: US 2002/0006858 A1
(43) Pub. Date: Jan. 17, 2002

(54) Methods for increasing absorption of microwave energy by compounds with a low dielectric constant

(76) Inventors: Scott F. Timmons, San Antonio, TX (US); Renee C. Graef, San Antonio, TX (US); Stuart T. Schwab, Albuquerque, NM (US); Montgomery D. Grimes, North Chelmsford, MA (US)

Correspondence Address: Paula D Morris & Associates, PC, 2925 Briarpark Drive, Suite 930, Houston, TX, 77042-3728, US

(21) Appl. No.: 09/776,317

(22) Filed: Feb. 2, 2001

Related U.S. Application Data
(63) Continuation of application No. 09/433,115, filed on Nov. 3, 1999, now abandoned.
Application No. 09/433,115 is a continuation-in-part of application No. 08/957,510, filed on Oct. 24, 1997, now abandoned.

(51) Int. Cl. C04B 35/563; C04B 35/565; C04B 35/583; C04B 35/584

(52) U.S. Cl. 501/87; 501/88; 501/96.3; 501/96.4; 501/97.1

(57) ABSTRACT

Low dielectric compounds, preferably silicon nitride precursors such as polycarbosilazanes, are mixed with a sufficient quantity of a silicon carbide additive to enhance absorption of electromagnetic energy by the mixture, thereby permitting efficient and effective curing of low dielectric compounds using electromagnetic energy.

This application is a continuation of application Ser. No. 09/433,115, currently pending, which is a continuation-in-part of application Ser. No. 08/957,510, filed Oct. 24, 1997 and issued on Nov. 9, 1999, as U.S. Pat. No. 5,980,699.

### FIELD OF THE INVENTION

The invention is directed to methods for increasing the effectiveness of microwave energy in processing compositions having a low dielectric constant. More particularly, the invention is directed to treating compounds having a low dielectric constant with microwave energy wherein the low dielectric compounds comprise additives that are effective to increase the ability of these compounds to absorb microwave energy.

### BACKGROUND OF THE INVENTION

Microwave energy has become an important alternate source of energy for “processing” a variety of compositions. The use of microwave energy generally costs less than heating a pyrolytic furnace to high temperatures. Microwave processing also often is safer and quicker than pyrolysis.

One field where the use of microwave energy has tremendous potential is the field of advanced ceramics. Advanced ceramics have promise in a wide variety of high technology and high temperature applications. Although substantial market growth has been predicted for some years for advanced ceramics and advanced ceramic composites, the expected growth has not occurred at least in part due to the high cost associated with producing and fabricating advanced ceramics. Due to their high cost, advanced ceramics and composites simply cannot compete with cheaper metals or polymers in many applications.

The use of microwave energy instead of high temperature sintering to process advanced ceramic precursors could substantially reduce the cost of advanced ceramics. Unfortunately, some of the compounds used as precursors to advanced ceramics, such as silicon nitride precursors, have a low dielectric constant. As a result, these compounds have difficulty absorbing microwave energy. Microwave energy has proven to be of limited value in processing low dielectric compounds. Methods are needed for increasing the ability of low dielectric compounds to absorb microwave energy, preferably without adversely impacting the purity of the end product.

### SUMMARY OF THE INVENTION

A method comprising adding to at least one non-gaseous low dielectric compound a quantity of an additive effective to enhance absorption of electromagnetic energy and to result in a cured product having an effective purity, said additive being selected from the group consisting of borides, carbides, silicides, nitrides, phosphides, and arsenides of metallic and semi-conducting elements.

### DETAILED DESCRIPTION OF THE INVENTION

The present invention involves the discovery of a way to enhance the microwave-absorbability of compounds with a low dielectric constant. As used herein, the phrase “low dielectric compound” is defined to refer to organic compounds which do not cure in 1000 seconds or less upon exposure electromagnetic energy at a power of from about 1 kW to about 5 kW derived either from (a) a millimeter wave energy source having a frequency in the range of from about 30 GHz to about 300 GHz, or (b) a microwave energy source should having a frequency in the range of from about 0.5 GHz to about 30 GHz. Examples of low dielectric compounds include, but are not necessarily limited to silazanes, preferably polycarbosilazanes.

The present invention involves the discovery that the microwave-absorbability of low dielectric compounds can be enhanced by adding to such compounds a sufficient quantity of an additive. The additives preferably do not adversely impact the desired purity and/or properties of the final product.

The microwave-absorbability of substantially any low dielectric compound can be enhanced using the method of the present invention. Preferred precursors for use in the invention include, but are not necessarily limited to ceramic precursors. Preferred ceramic precursors are low dielectric precursors that are used to make ceramics and ceramic composites comprising silicon nitride (Si₃N₄), including α-Si₃N₄ ceramic and β-Si₃N₄ ceramic, and silicon nitride composites. Preferred silicon nitride ceramic precursors include but are not necessarily limited to polysilazanes, preferably perhydridopolysilazanes and polycarbosilazanes.

Preferred substituted polycarbosilazanes comprise units independently selected from the group consisting of those having the following general structure:

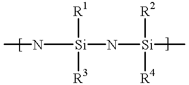

wherein R¹, R², R³, and R⁴ independently are selected from the group consisting of hydrogen, and alkyl groups and alkylene groups having from about 1 to about 6 carbon atoms, provided that at least one of R¹, R², R³, and R⁴ contains carbon. In a preferred embodiment, R¹ and R² are methyl groups and R³ and R⁴ are hydrogens.

Additives suitable for use in the present invention include, but are not necessarily limited to borides, carbides, silicides, nitrides, phosphides, and arsenides of metallic and semi-conducting elements, such as Si, Ga, and In. A preferred additive comprises a material selected from the group consisting of silicon carbide (SiC), silicon nitride (Si₃N₄), silicon boride, boron nitride, boron carbide, carbon, carbon fibers, carbon fibers with coatings, and mixtures thereof.

The foregoing additives can be purchased from various commercial sources. Boron nitride, boron phosphide, boron carbide, silicon nitride, indium phosphide and gallium arsenide are available from Johnson Matthey Catalog Company (Alfa®/AESAR®). Silicon carbide, silicon boride, and silicon nitride can be purchased from the Aldrich Chemical Company and Fluka Chemie AG. A most preferred additive is silicon carbide, which may be purchased from H. C. Starck, Newton, Massachusetts.

SiC precursors also may be added to ceramic SiN precursors in order to increase the electromagnetic-absorbability of the ceramic precursor mixture. Suitable SiC precursors for such addition include, but are not necessarily limited to polysilanes, preferably polycarbosilanes, most preferably allyl hydridopolycarbosilanes.

Several factors determine how much of the microwave absorption-enhancing additive is used. The factors include, but are not necessarily limited to, the selected low dielectric constant compound, the desired product, the electromagnetic energy source and its power, and the processing conditions. The amount of additive used to prepare silicon nitride ceramics and ceramic composites is an amount effective to produce a product comprising from about 0.01 wt. % to about 99 wt. %, preferably from about 10 wt. % to about 50 wt. % of the final silicon nitride or silicon nitride composite product.

Once the precursors are selected, the precursor mixture is subjected to an electromagnetic energy source of sufficient power for a time and under conditions effective to cause the conversion to the desired product. An electromagnetic energy source is suitable for use in the invention as long as the source has a proper frequency and sufficient power to heat the precursor mixture to a desired temperature for a desired period of time under conditions effective to convert the precursor to the desired product, preferably a ceramic or ceramic composite, in a relatively short period of time. A batch, semi-continuous, or continuous mode of operation may be suitable for the conversion.

Preferred electromagnetic energy sources have a frequency region selected from the group consisting of a millimeter wave region and a microwave region. A millimeter wave energy source should have a frequency in the range of from about 30 GHz to about 300 GHz, more preferably in the range of from about 30 GHz to about 50 GHz. A microwave energy source should have a frequency in the range of from about 0.5 GHz to about 30 GHz, more preferably in the range of from about 1 GHz to about 27 GHz. The energy sources preferably should have a power in the range of from about 0.1 kW to about 10 kW, most preferably in the range of from about 1 kW to about 5 kW.

A preferred “converting time” for converting the ceramic precursor to a ceramic or ceramic composite is shorter than the time required using conventional heating techniques. A preferred “converting time” will depend on the ceramic precursor, the type and amount of the substituents, the composition of the preceramic intermediate, the electromagnetic energy source and its power, and other reaction conditions. Suitable “converting time” periods are in the range of from about 10 seconds to about 1000 seconds, preferably in the range of from about 30 seconds to about 120 seconds, and most preferably in the range of from about 60 seconds to about 90 seconds.

A suitable “converting pressure” for converting a preceramic intermediate to a ceramic or ceramic composite product is in the range of from about 10 kPa to about 5000 kPa, preferably in the range of from about 100 kPa to about 3000 kPa.

An “effective purity level” is at least about 60 wt. % of a desired product, preferably 70 wt. % or more, more preferably 80 wt. % or more, and most preferably 90 wt. % or more. In a most preferred embodiment, the purity is about 95 wt. % or more. In the case of polycarbosilazanes and allyl hydridopolysilanes, the desired product is silicon nitride with a remainder of silicon carbide and silicon. The purity of the product produced from the combination of a polysilazanes and a polysilanes is at least about 60 wt. % or more Si₃N₄, preferably about 70 wt. % or more Si₃N₄, most preferably about 80 wt. % or more Si₃N₄, and most preferably about 90 wt. % Si₃N₄ or more Si₃N₄, with a most preferred embodiment resulting in 95 wt. % or more Si₃N₄, the remainder being silicon carbide and elemental silicon. Ceramic and ceramic composite products may be characterized using the X-ray Diffraction (XRD) method described by C. R. Blanchard and S. T. Schwab, in Journal of American Ceramic Society, 77, p. 1729 (1994), incorporated herein by reference.

Where the precursor used is a polycarbosilazane, the silazane preferably is stored, handled and manipulated in an inert atmosphere to minimize exposure to oxygen and water. Gases useful for providing the inert atmosphere include, but are not necessarily limited to helium, neon, argon, krypton, nitrogen, hydrogen, and mixtures thereof. The inert atmosphere may be static or flowing. In a flowing inert atmosphere, flow rates of the inert gas are in the range of from about 0.1 ft/min to about 30 ft/min, preferably in the range of from about 1 ft/min to about 10 ft/min.

In addition to using an inert atmosphere, other similar synthetic techniques for manipulating air or water sensitive materials may be used. Such techniques include using an inert atmosphere/vacuum manifold system and an inert atmosphere filled “dry box.” The commercial models used in the following Examples were Vacuum Atmospheres HE-43-2 with HE-493 Dritrain®. Many suitable techniques are described by D. F. Shriver and M. A. Drezdzon in The Manipulation of Air-Sensitive Compounds (John Wiley, New York, N.Y. 2nd ed. 1986), and by A. L. Wayda and M. Y. Darensbourg, in Experimental Organometallic Chemistry (American Chemical Society Symposium Series 357, American Chemical Society, Washington, D.C. 1987), both of which are incorporated herein by reference.

Persons of ordinary skill in the art will recognize that many modifications may be made to the present invention without departing from the spirit and scope of the invention. The embodiment described herein is meant to be illustrative only and should not be interpreted as limiting the present invention, which is defined in the following claims.

We claim:

1. A method comprising adding to at least one non-gaseous low dielectric compound a quantity of an additive effective to enhance absorption of electromagnetic energy and to result in a cured product having an effective purity, said additive being selected from the group consisting of borides, carbides, silicides, nitrides, phosphides, and arsenides of metallic and semi-conducting elements.

2. The method of claim 1 wherein said additive is selected from the group consisting of silicon carbide, silicon nitride, silicon boride, boron nitride, boron carbide, carbon, carbon fibers, carbon fibers with coatings, and mixtures thereof.

3. A method comprising adding to at least one non-gaseous low dielectric compound a quantity of an additive comprising silicon carbide effective to enhance absorption of electromagnetic energy and to result in a cured product having an effective purity.

4. The method of claim 3 wherein said additive consists essentially of silicon carbide.

5. The method of claim 1 wherein said low dielectric compounds are polysilazanes.

6. The method of claim 1 wherein said low dielectric compounds are polycarbosilazanes.

7. The method of claim 1
wherein said electromagnetic energy source selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

4. The method of claim 2
wherein said electromagnetic energy source selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

5. The method of claim 3
wherein said electromagnetic energy source selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

6. The method of claim 3 wherein said polycarbosilazane comprises substituents selected from the group consisting of alkyl groups and alkylene groups having from about 1 to about 6 carbon atoms.

7. The method of claim 5 wherein said polycarbosilazane comprises substituents selected from the group consisting of an alkyl group and an alkylene group having from about 1 to about 6 carbon atoms.

8. A method comprising treating a ceramic precursor mixture comprising an additive and a silicon nitride precursor selected from the group consisting of a polycarbosilazanes and perhydridopolysilazanes with electromagnetic energy at a sufficient power, for a sufficient time, and under conditions effective to cure said ceramic precursor mixture to produce a cured final product comprising predominantly silicon nitride having an effective purity level, said additive being present in an amount effective to enhance absorption of said electromagnetic energy by said ceramic precursor mixture, said additive being selected from the group consisting of borides, carbides, silicides, nitrides, phosphides, and arsenides of metallic and semi-conducting elements.

9. The method of claim 8 wherein said additive is selected from the group consisting of silicon carbide, silicon nitride, silicon boride, boron nitride, boron carbide, carbon, carbon fibers, carbon fibers with coatings, and mixtures thereof.

10. The method of claim 8 wherein said additive consists essentially of silicon carbide.

11. The method of claim 8
wherein said electromagnetic energy source is selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

12. The method of claim 9
wherein said electromagnetic energy source selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

13. The method of claim 10
wherein said electromagnetic energy source selected from the group consisting of a millimeter wave energy source and a microwave energy source, and
said millimeter wave energy source has a frequency in the range of from about 30 GHz to about 300 GHz; and
said microwave energy source has a frequency in the range of from about 0.5 GHz to about 30 GHz.

14. The method of claim 8 wherein
said power is in the range of from about 0.1 kW to about 10 kW; and
said sufficient time is up to about 1000 seconds.

15. The method of claim 9 wherein
said power is in the range of from about 0.1 kW to about 10 kW; and
said sufficient time is up to about 1000 seconds.

16. The method of claim 10 wherein
said power is in the range of from about 0.1 kW to about 10 kW; and said sufficient time is up to about 1000 seconds.

17. The method of claim 11 wherein
said power is in the range of from about 0.1 kW to about 10 kW; and
said sufficient time is up to about 1000 seconds.

18. The method of claim 12 wherein
said power is in the range of from about 0.1 kW to about 10 kW; and
said sufficient time is up to about 1000 seconds.

19. The method of claim 13 wherein
said power is in the range of from about 0.1 kW to about 10 kW; and
said sufficient time is up to about 1000 seconds.

20. The method of claim 8 wherein said polycarbosilazane comprises units having the following general structure: 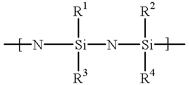
wherein R¹, R², R³, and R⁴ independently are selected from the group consisting of hydrogen, and alkyl groups and alkylene groups having from about 1 to about 6 carbon atoms.

21. The method of claim 20 wherein R¹ and R² are methyl groups, and R³ and R⁴ are hydrogens.

22. The method of claim 9 wherein said polycarbosilazane comprises units having the following general structure: 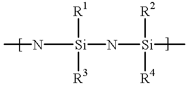
wherein R¹, R², R³, and R⁴ independently are selected from the group consisting of hydrogen, and alkyl groups and alkylene groups having from about 1 to about 6 carbon atoms.

23. The method of claim 22 wherein R¹ and R² are methyl groups, and R³ and R⁴ are hydrogens.

24. The method of claim 10 wherein said polycarbosilazane comprises units having the following general structure: 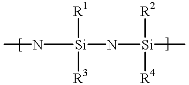
wherein R¹, R², R³, and R⁴ independently are selected from the group consisting of hydrogen, and alkyl groups and alkylene groups having from about 1 to about 6 carbon atoms.

25. The method of claim 24 wherein R¹ and R² are methyl groups, and R³ and R⁴ hydrogens.

26. The method of claim 11 wherein said polycarbosilazane comprises units having the following general structure: 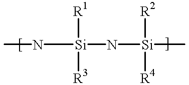
wherein R¹, R², R³, and R⁴ independently are selected from the group consisting of hydrogen, and alkyl groups and alkylene groups having from about 1 to about 6 carbon atoms.

27. The method of claim 26 wherein R¹ and R² are methyl groups, and R³ and R⁴ are hydrogens.

28. The method of claim 12 wherein said polycarbosilazane comprises units having the following general structure: 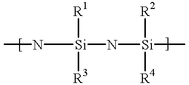
wherein R¹, R², R³, and R⁴ independently are selected from the group consisting of hydrogen, and alkyl groups and alkylene groups having from about 1 to about 6 carbon atoms.

29. The method of claim 28 wherein R¹ and R² are methyl groups, and R³ and R⁴ are hydrogens.

30. The method of claim 13 wherein said polycarbosilazane comprises units having the following general structure: 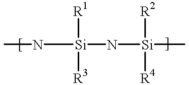
wherein R¹, R², R³, and R⁴ independently are selected from the group consisting of hydrogen, and alkyl groups and alkylene groups having from about 1 to about 6 carbon atoms.

31. The method of claim 30 wherein R¹ and R² are methyl groups, and R³ and R⁴ are hydrogens.

32. The method of claim 14 wherein said polycarbosilazane comprises units having the following general structure: 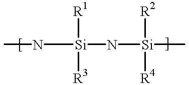
wherein R¹, R², R³, and R⁴ independently are selected from the group consisting of hydrogen, and alkyl groups and alkylene groups having from about 1 to about 6 carbon atoms.

33. The method of claim 32 wherein R¹ and R² are methyl groups, and R³ and R⁴ are hydrogens.

34. The method of claim 15 wherein said polycarbosilazane comprises units having the following general structure: 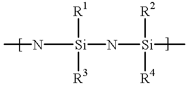
wherein R¹, R², R³, and R⁴ independently are selected from the group consisting of hydrogen, and alkyl groups and alkylene groups having from about 1 to about 6 carbon atoms.

35. The method of claim 34 wherein R¹ and R² are methyl groups, and R³ and R⁴ are hydrogens.

36. The method of claim 16 wherein said polycarbosilazane comprises units having the following general structure: 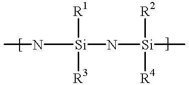
wherein R¹, R², R³, and R⁴ independently are selected from the group consisting of hydrogen, and alkyl groups and alkylene groups having from about 1 to about 6 carbon atoms.

37. The method of claim 36 wherein R¹ and R² are methyl groups, and R³ and R⁴ are hydrogens.

38. The method of claim 17 wherein said polycarbosilazane comprises units having the following general structure: 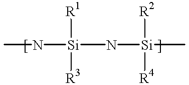
wherein R¹, R², R³, and R⁴ independently are selected from the group consisting of hydrogen, and alkyl groups and alkylene groups having from about 1 to about 6 carbon atoms.

39. The method of claim 38 wherein R¹ and R² are methyl groups, and R³ and R⁴ are hydrogens.

40. The method of claim 18 wherein said polycarbosilazane comprises units having the following general structure: 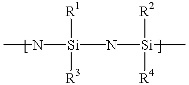
wherein R¹, R², R³, and R⁴ independently are selected from the group consisting of hydrogen, and alkyl groups and alkylene groups having from about 1 to about 6 carbon atoms.

41. The method of claim 40 wherein R¹ and R² are methyl groups, and R³ and R⁴ are hydrogens.

42. The method of claim 19 wherein said polycarbosilazane comprises units having the following general structure: 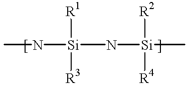
wherein R¹, R², R³, and R⁴ independently are selected from the group consisting of hydrogen, and alkyl groups and alkylene groups having from about 1 to about 6 carbon atoms.

43. The method of claim 42 wherein R¹ and R²are methyl groups, and R³ and R⁴ are hydrogens.
